(19) United States
(12) Patent Application Publication
(10) Pub. No.: US 2017/0068784 A1
(43) Pub. Date: Mar. 9, 2017

(54) METHODS AND SYSTEMS FOR HEALTH CARE INFORMATION MANAGEMENT

(71) Applicant: United States Postal Service, Washington, DE (US)

(72) Inventors: Kelley A. Sullivan, Washington, DC (US); Douglas Paul Glair, Baltimore, MD (US)

(21) Appl. No.: 15/254,990

(22) Filed: Sep. 1, 2016

Related U.S. Application Data
(60) Provisional application No. 62/214,376, filed on Sep. 4, 2015.

(51) Int. Cl. G06F 19/00; G06F 21/62

(52) U.S. Cl. CPC G06F 19/322; G06F 19/328; G06F 21/6245

(57) ABSTRACT

Methods and systems for management of health care information include, in one aspect, a method including receiving input, via an electronic device, associating one or more additional individuals with the health care information, receiving electronic contact information for at least one of the additional individuals, receiving, via an electronic device, a request to access the health care information, presenting a prompt to the at least one of the additional individuals via their respective electronic contact information in response to the request, receiving second input indicating how the request should be processed, and processing the request based on the second input.

### CROSS REFERENCE TO RELATED APPLICATIONS

This application claims priority to U.S. Provisional Application No. 62/214,376, filed Set. 4, 2015, and entitled “METHODS AND SYSTEMS FOR HEALTH CARE INFORMATION MANAGEMENT.” The content of this prior application is considered part of this application, and is hereby incorporated by reference in its entirety.

### FIELD

This disclosure relates to the management of healthcare information, and more particularly, to facilitating the management of an individual's healthcare information via the use of an alerting system.

### BACKGROUND

Most health information exchanges today are focused on institution-to-institution transfer, and do not consider patient access to—or maintenance of—personal health data. Moreover, they must abide by strict patient privacy regulations under The Health Insurance Portability and Accountability Act (HIPAA), and none have a fully functional patient portal.

The Veteran's Administration originated the “Blue Button,” as a symbol on its patient portal that beneficiaries could click to securely download their own health record electronically. Since then, the Blue Button has spread beyond the VA to other government agencies and the private sector. Responsibility for encouraging broader use of Blue Button and enhancing its technical standards was transferred to the Office of the National Coordinator for Health Information Technology (ONC), part of the Department of Health and Human Services, in 2012.

Via the Blue Button Pledge Program, more than 450 organizations make personal health data available to Americans via their healthcare providers, health insurance companies, labs, and drug stores; building tools to make health information actionable for patients; and/or spreading the word about why all this matters.

As America's healthcare system rapidly goes digital, these organizations are starting to give patients and consumers access to their health records electronically through the “Blue Button” mechanism, which allows consumers to take action—download your own health information and use it!

Blue Button has also become a rallying cry for achieving the potential of patients and their families to engage via better health information and tools Blue Button and is becoming a movement.

Blue Button allows people to view and download their personal health information, and to share it with people they trust. With over 2 million users and a growing addressable market of over 100 million, over 400 companies have taken the “Blue Button pledge.” Thousands of software developers, clinicians, health plan administrators, and patient advocates are engaged with Blue Button. They participate in Blue Button hack-a-thons, run Blue Button conferences, and lead foundation efforts to promote consumer-centered access to care.

### SUMMARY

Methods and apparatuses or devices disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description” one will understand how the features being described provide advantages that include data authentication services.

### BRIEF DESCRIPTION OF THE DRAWINGS

Drawings and the associated description herein are provided to illustrate specific embodiments of the invention and are not intended to be limiting.

FIG. 1 is an illustration of a health information exchange (HIE)/health information service provider network.

FIG. 2 illustrates a common situation in today's health care delivery system.

FIG. 3 is an illustration of an improved health care information network.

FIG. 4 shows a user story that is made possible by the health information network shown in FIG. 3.

FIG. 5A shows one example configuration of a computer system implementing a health information exchange over the Internet.

FIG. 5B is a functional block diagram of an apparatus that may be configured to perform one or more of the disclosed embodiments.

FIG. 6A is a user interface that may be displayed on any of the client devices shown in FIG. 5A.

FIG. 6B is a user interface to request authorization for a database access.

FIG. 7 is a user interface displayed in some implementations of the disclosed methods and systems.

FIG. 8 is a user interface displayed in some implementations of the disclosed methods and systems.

FIG. 9 is a user interface displayed in some implementations of the disclosed methods and systems.

FIG. 10 is a user interface displayed in some implementations of the disclosed methods and systems.

FIG. 11 is a user interface displayed in some implementations of the disclosed methods and systems.

FIG. 12 is a user interface displayed in some implementations of the disclosed methods and systems.

FIG. 13 is a user interface displayed in some implementations of the disclosed methods and systems.

FIG. 14 is a user interface displayed in some implementations of the disclosed methods and systems.

FIG. 15 is a user interface displayed in some implementations of the disclosed methods and systems.

FIG. 16 is a flowchart of a method of prompting for authorization to access health care information that may be implemented in at least some of the disclosed embodiments.

FIG. 17 is a flowchart of a method of prompting for authorization for a medical procedure to be performed.

FIG. 18 is a flowchart of a method of alerting based on health information.

FIG. 19 is a flowchart of a method of verifying changes to a user's authentication information.

### DETAILED DESCRIPTION

Currently, health information is not easily shared between various entities in a health care system, and all too often cannot be accessed on a secure, timely basis. This creates a host of issues for all major stakeholders. For example, the value of a payor (such as an insurance company) network is limited by regulatory and security concerns which constrain digital communication across the networks, forcing a reliance on fax, paper and phone. Additionally, accessing out-of-network information by providers is time consuming. Consumers can not generally be relied upon to provide accurate information. Consumers also cannot easily access their health information or communicate with providers digitally, and worry about the privacy of their information through digital channels. Corporate customers face rising healthcare costs, and their health and wellness programs lack the data they need to be effective.

The next step in the rapid evolution of Blue Button patient-centered care will be the emergence of personal health data repositories, which can be physical, virtual, and federated, and allow patients to access their information and share it with their parents, their partners, their children, and their delegates. Via the methods and systems disclosed herein the following benefits may be achieved:

“One stop” aggregated access to health care information that is reliable, private, and secure allows patients to centralize their health information from a variety of disparate sources and formats, including commercial pharmacies, specialty care providers, diagnostic laboratories, and insurance company claims records. The consumer-mediated Blue Button model for patient exchange may dramatically improve continuity of care, lower unit delivery costs, and most importantly of all, reduce medical errors and improve systemic safety. As a result medical service providers may have ready access to comprehensive and complete patient-centered (and controlled) information, which will obviate the need for redundant tests, avoid drug-drug and drug-nutrient interactions, and provide an up-to-date and scientifically sound basis of evidence-based clinical decision support.

Advantages of the Blue Button model include improved efficiency and time management for employees by enabling access to medical data and analytics that leads to better quality of care. Blue Button also provides a technology platform to leverage identity management for personal digital services, beginning with patient-centered health information exchange. Blue Button establishes a digital platform that is transferrable and scalable to other sectors, and creates a secure repository for sensitive information storage and review. The system also provides for automation of paper-based processes with a digital solution.

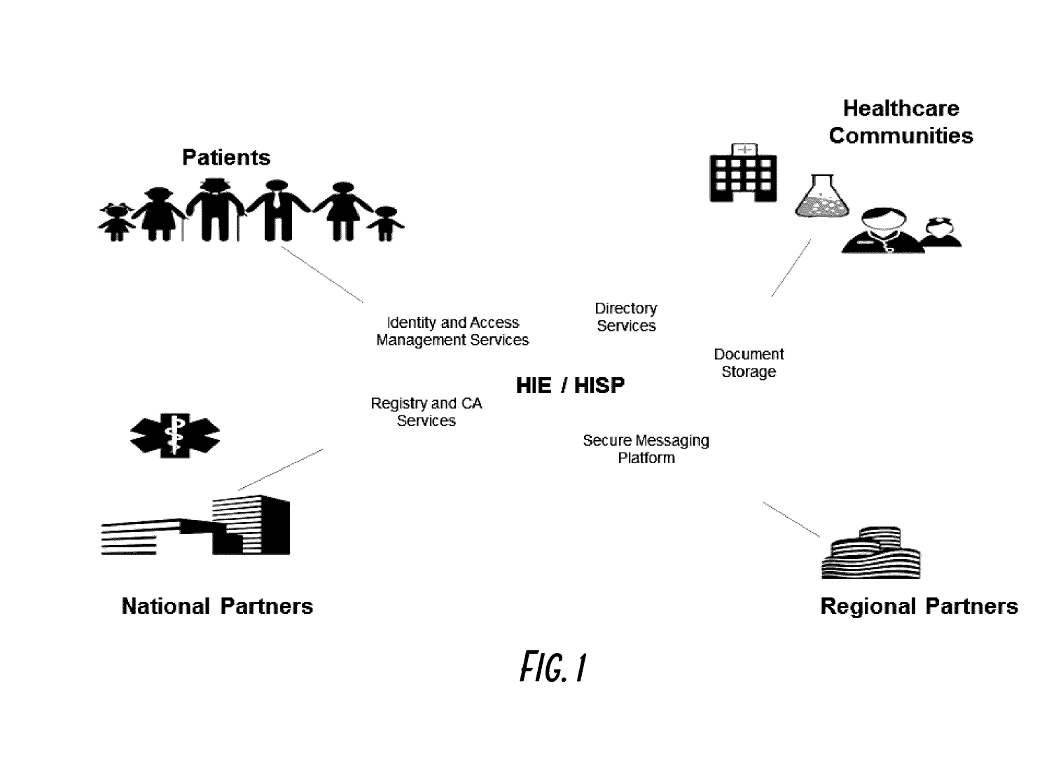

FIG. 1 is a system diagram illustrating a health information exchange (HIE)/health information service provider network. A health information exchange may be a health information organization or network that brings together health care stakeholders within a defined geographic area and governs electronic healthcare record (HER) exchanges among them for the purpose of improving health care in that community. Currently, there are at least 161 private and 67 public HIE's in operation in the United States. In some cases, a company or other organization may rely on a health information service provider to connect to a nationwide health information network, instead of implementing a health information exchange themselves. For example, smaller organizations may be unable to provide the technology and other resources necessary to maintain their own connection to the nationwide health information network. A health information service provider (HISP) may include at least one common approach to data transport, a routing directory, and a certificate management process that creates a trust fabric. In some cases, a HISP may utilize the direct protocol, which is a set of simple standards and a policy framework, to securely send encrypted health information to known recipients over the Internet.

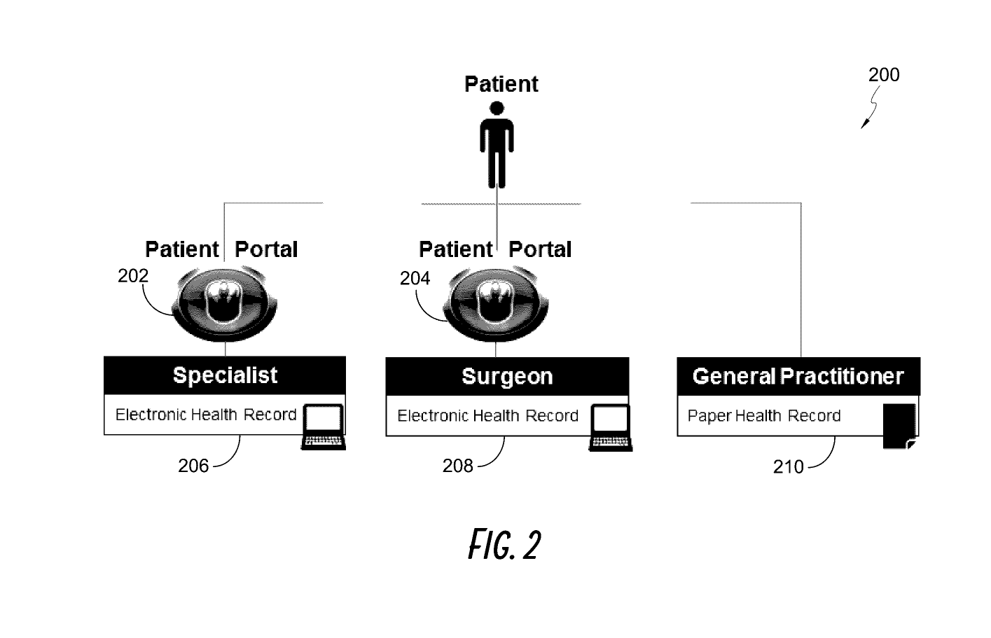

FIG. 2 illustrates a common situation in today's health care delivery system. FIG. 2 shows a patient interacting with at least three different health care providers, a specialist, a surgeon, and a general practitioner. Each of the specialists and surgeons provide their own individual practice portals 202 and 204 respectively for their patents. Each of the practice portals 202 and 204 make use of electronic health records 206 and 208 respectively. In the scenario illustrated by FIG. 2, the general practitioner has not yet embraced electronic methods of health care information management, and instead relies on paper based health records 210. Additionally, the practice portals 202 and 204 are not integrated with any larger regional or national health care network, but instead operate as individual silos of information, covering only health care information relating to the particular practice of the specialist and/or surgeon.

A patient lacks choice in the system of FIG. 2. An electronic health record is not accessed or offered by all physicians. The multiple software applications/portals are not interoperable, and there is little if any portability. Additionally, there is no standardized identity management process between the practice portals that do exist, such as practice portals 202 and 204. Thus, any user id/password needed to access each of the practice portals 202 and 204 may be different. The level of security, such as file encryption, and privacy related attributes may vary or be unknown to the patient. Additionally, there is no guaranteed persistence of patient information. For example, if a provider goes out of business, the patient may have no way to recover the information stored at the provider.

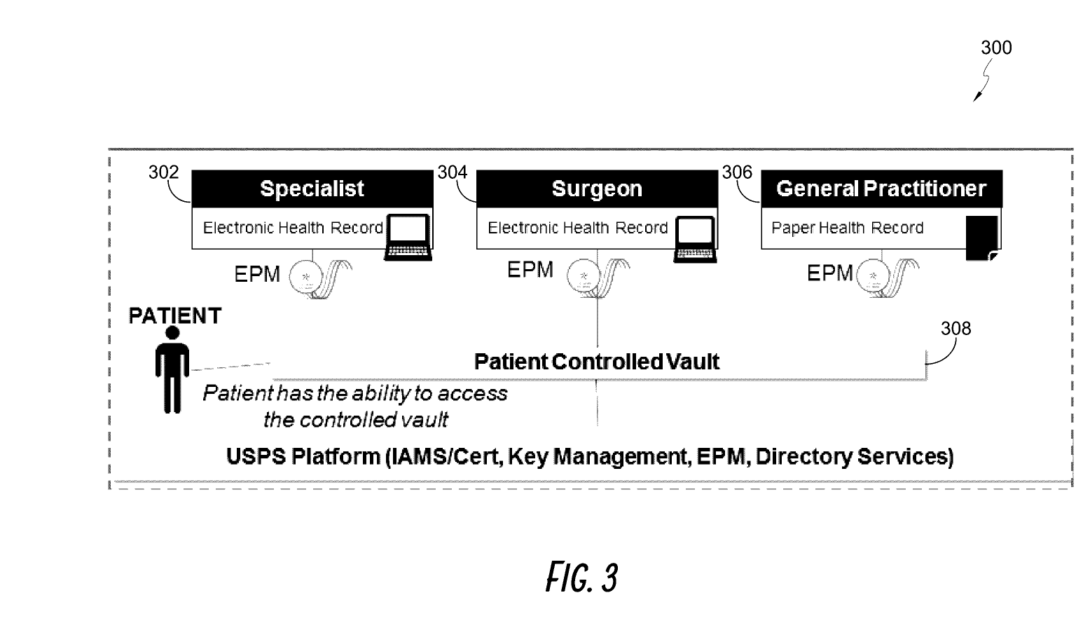

FIG. 3 is an illustration of an improved health care information network. In FIG. 3, each of a patient's health care providers, a specialist, surgeon, and general practitioner, make use of electronic health records, 302, 304, and 306. The providers do not maintain master copies of the health records themselves however. Instead, the master copies are stored in a patent controlled health information vault 308. The patient controlled health information vault 308 may be any data store that is accessible via a network. Access to a particular patient's health care information stored within the vault requires permission from the patient.

When the patient consults with any of the specialist, surgeon and/or general practitioner, they also grant permission for that provider to access their medical records within the patient controlled vault 308. The patient also has the ability, through another portal application (not shown) to access their health care information that is stored in the patient controlled vault 308.

With the health care network shown in FIG. 3, a patient may be provided with an enhanced ability to choose how they interact with their health care providers. For example, a patient may be able to access their health care information across multiple providers regardless of application, because these systems may be seamlessly integrated across multiple different software applications. Using the United States Digital Service (USDS), patients may be able to choose which of several available vaults are used to store their health information, push a health record to a particular provider/physician/organization, and/or receive a record from a provider/physician/organization. The system shown in FIG. 3 may have a standardized and simplified identity management process. This may allow the patient or any provider to potentially access all electronic health records via one centralized USDS proofed, issued and managed credential. Additionally, validation that a message moved from sender to receiver with the highest level of message integrity may be provided. The system may utilize electronic postmarks to provide date time stamps with non-repudiation of messages.

Additionally, with the system of FIG. 3, a patient may maintain control of information retention, because the patient controls the storage and retention of their own information. In some implementations, data may be “housed” in a shared central repository and updated based on defined policies and procedures that span interoperable requirements to privacy and security policy and procedures.

The system of FIG. 3 has several advantages. First; it provides a uniform data format supporting a high degree of data interoperability, and provides a cohesive, centralized system with defined methods, procedures and policies for access, maintenance and management/control. However, the system also requires strong political and governance oversight and management of data ownership and control. The system is also more complex that the system shown in FIG. 3, and provides more complex and challenging implementations ranging from technical scalability to support of privacy and security policies.

Some implementations of the system of FIG. 3 may use a federated model, where health care data stays at the patient controlled vault 308. This solution maintains custodianship and control over the data. When requested, the data is queried from the data source organization. The federated architecture provides for the easiest and quickest way to achieve exchange of health information, and limits conflict over data ownership. With the federated model, management of authorized and legitimate access to third party systems may be necessary. An alternative implementation is to use a hybrid model, which provides a combination of centralized and federated models specific to each HIE entity setup, socioeconomic, political and geographic environments, size, etc. This may provide more flexibility when compared to the pure federated model.

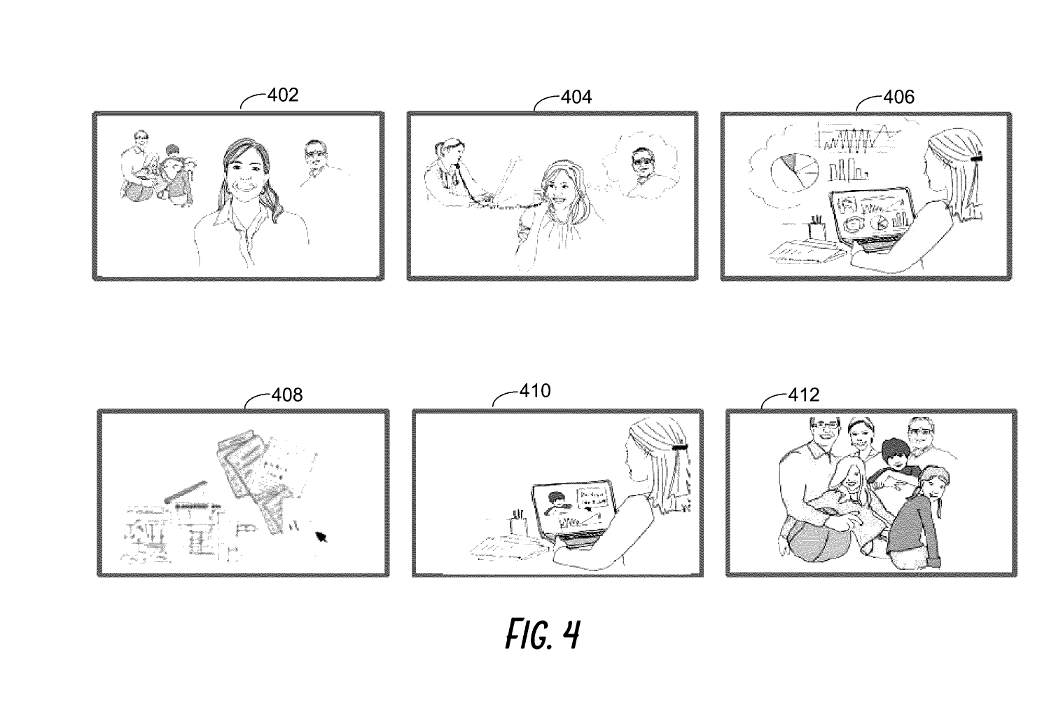

FIG. 4 shows a user story that is made possible by the health information network shown in FIG. 3. In slide 402, Joan, a parent and caregiver to her elderly father is introduced. In slide 404, Joan is concerned about her father's health, so she enrolls in a health information exchange at the recommendation of his primary care provider (PCP). In slide 406, she reviews her father's medical information, which includes information about his medication, doctor appointments, and vital statistics. Joan's father has given his consent for Joan's access. In slide 408, Joan also enrolls her family in the health information exchange. Joan is now able to see the health records for her entire family. She can easily complete tasks that used to take time—link sending her kids vaccination records—with one click. Slide 410 demonstrates that Joan's family health information is now accessible anywhere, anytime, such that she can easily review the information outside of a doctor's office or other provider setting. Slide 412 demonstrates the benefits of a health information exchange. By centralizing storage of health information, Joan is able to focus on other aspects of life. For example, Joan can focus on being a supportive mom and daughter because her family's information is always accessible, in the right place, at the right time.

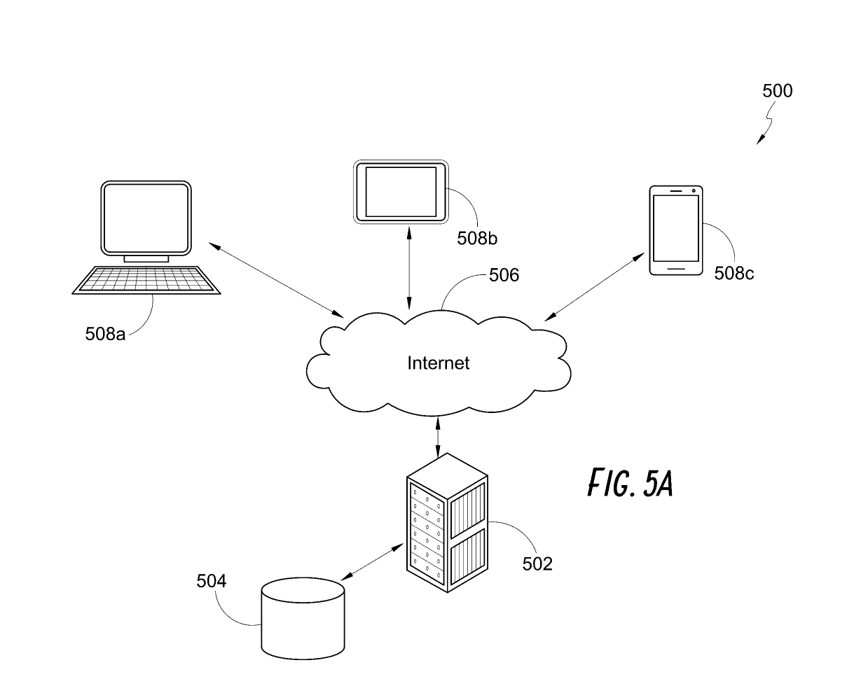

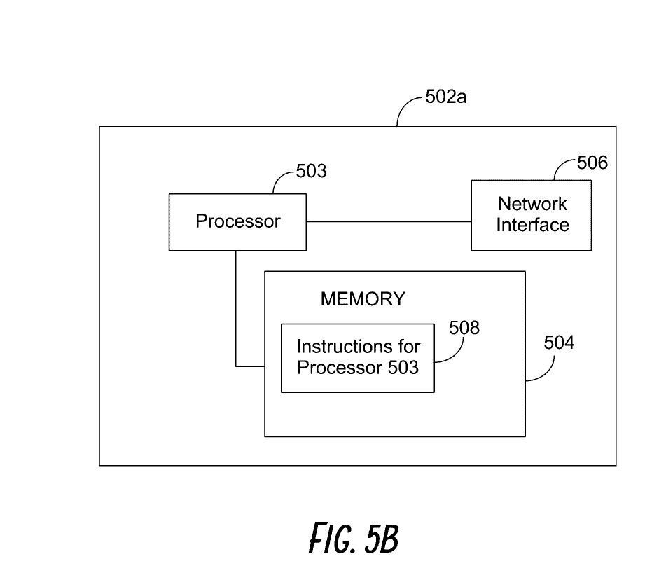

FIG. 5A shows one example configuration of a computer system implementing a health information exchange over a computer network, such as the Internet. The system 500 includes one or more servers 502 connected to a database 504. The one or more servers are in network communication with one or more health information exchange users over the Internet 506. The users may connect to the health information exchange using a variety of devices, including workstations/personal computers 508a, tablets, 508b, and/or mobile devices 508c.

FIG. 5B is a functional block diagram of an apparatus that may be configured to perform one or more of the disclosed embodiments. The apparatus 502a may in some aspects be one of the servers in the one or more servers 502 of FIG. 5A.

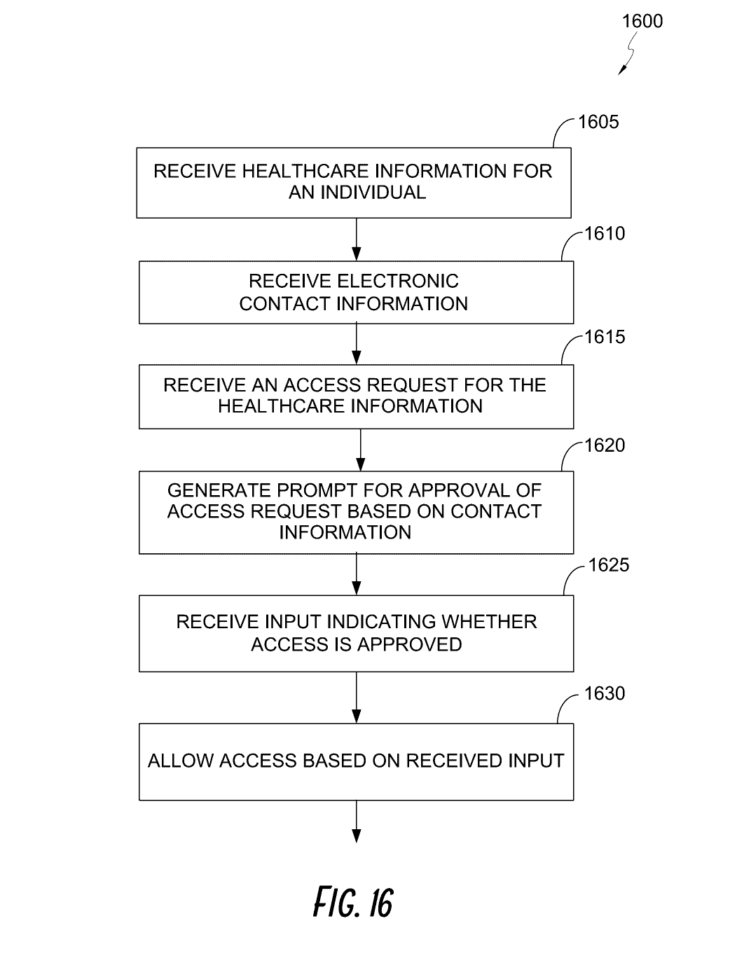

The apparatus 502a includes an electronic hardware processor 503, memory 504 operably connected to the processor 503, and a network interface 506 that is also operably connected to the processor 503. The memory stores instructions 508 that configure the processor to perform operations. The instructions may configure the processor 503 to perform one or more of the methods discussed here, such as one or more of methods 1600, 1700, 1800, and/or 1900 of FIGS. 16-19 respectively.

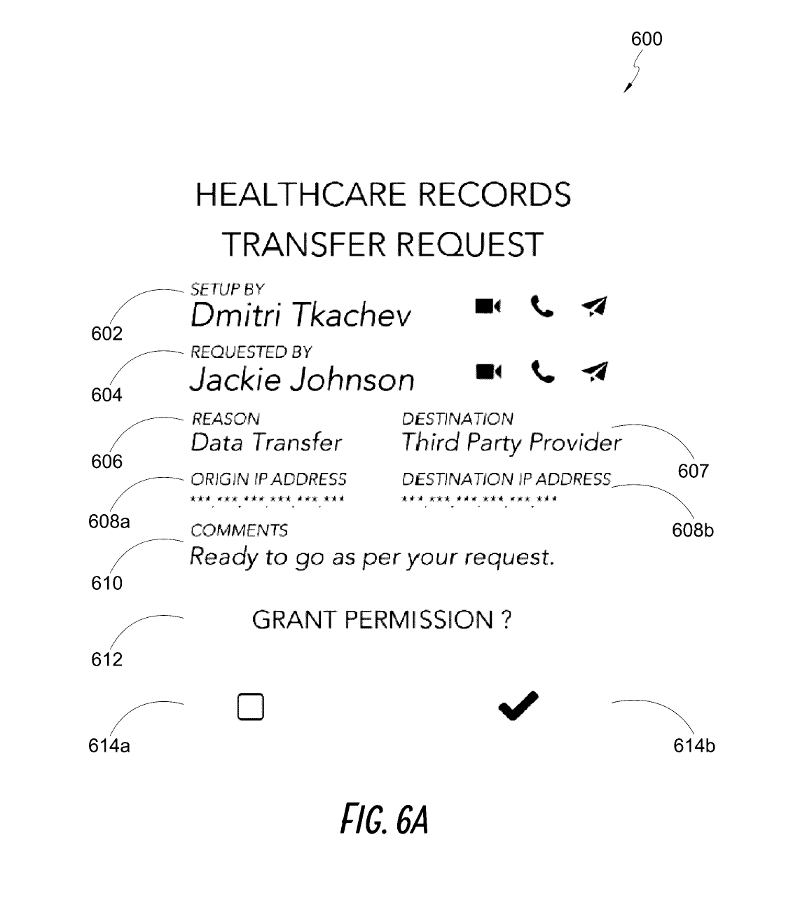

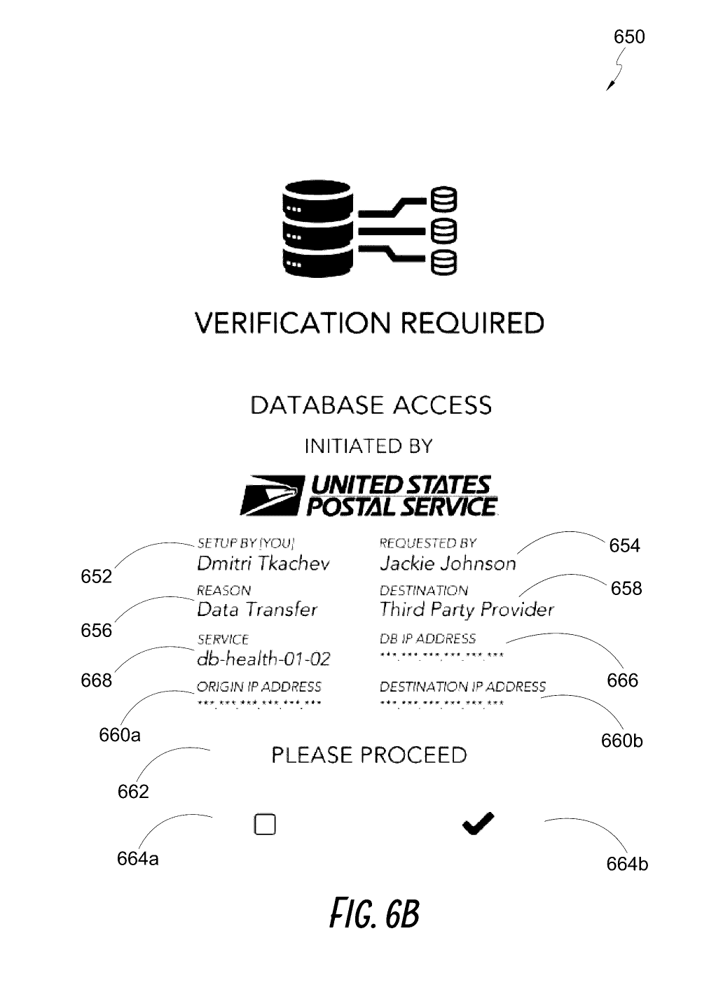

FIG. 6A shows a user interface that may be displayed on any of the client devices 508a-c shown in FIG. 5A. The user interface 600 may be displayed in response to receiving a heath care records transfer request for an individual. The health care records transfer request may be initiated, in various aspects, by either the individual themselves or a third party, such as a doctor's office.

The user interface 600 includes a variety of indications. In particular, the user interface 600 indicates who “set up” the request 602. The request may be “set up” by, for example, an administrator at an office initiating the transfer request. The user interface 600 also includes an indication of who requested the transfer request 604. The requestor differs from the individual who “set up” the request in that the requestor may be an original initiator of the transfer request, while the individual who “set up” the request is responsible for the logistics of making the request occur. The user interface also includes a reason indication 606. The reason may be provided by the requester, in this case “Jackie Johnson.” The user interface 600 also includes an indication of the destination of the healthcare records 607, in other words, where the present transfer request will send the health care records. The user interface 600 also includes indications of network addresses 608a-b. The indications may include source (608a) and destination (608b) IP addresses as shown. The user interface 600 also includes a comments indication 610. The comments may be entered by either the individual who “set up” the transfer request, or by the individual who “requested” the transfer request. The user interface 600 also includes a prompt 612, in this case, asking a user reviewing the user interface 600 whether they grant permission for the transfer request to proceed.

In some aspects, the user interface 600 is displayed to a user with administrative privileges to the healthcare records of the individual. This could be the individual themselves, or someone who has been granted permission to administer the individual's health care information, such as a parent or guardian or other family member. The user interface 600 also includes buttons 614a-b, which allow the user viewing the user interface 600 to either grant (614b) or deny (614a) permission for the transfer request to proceed.

FIG. 6B shows a user interface to request authorization for a database access. In some aspects, the user interface may be displayed on an electronic display of a user with administrative privileges to health care records to be modified by the database access which is the subject of the user interface 650. In some aspects, instructions 508 of device 502a, which is one of the one or more servers 502 of FIG. 5A, may configure the processor 503 to cause the user interface 650 to be displayed on the electronic display. In some aspects, the processor 503 may download instructions to one of the client devices 508a-c that implement a program that causes the user interface 650 to be displayed. For example, the one or more servers 502 may download a java program or other browser plug-in to the client devices 508a-c that cause the user interface 650 to be displayed. In other aspects, a client device 508a-c may include a mobile application that includes instructions that configure a processor on the mobile device 508a-c to display the user interface 650.

The user interface 650 includes several indications similar to that of user interface 600, described previously, including an indication of who “set up” the database access 652, who requested the database access 654, a reason indication 656, a destination for the information being obtained by the database access 658, source and destination IP addresses 660a-b. User interface also includes a prompt 662 and rejections and confirmation controls/buttons 664a-b. The database access authorization user interface 650 also includes an indication of a database IP address 666, and database service identifier indication 668.

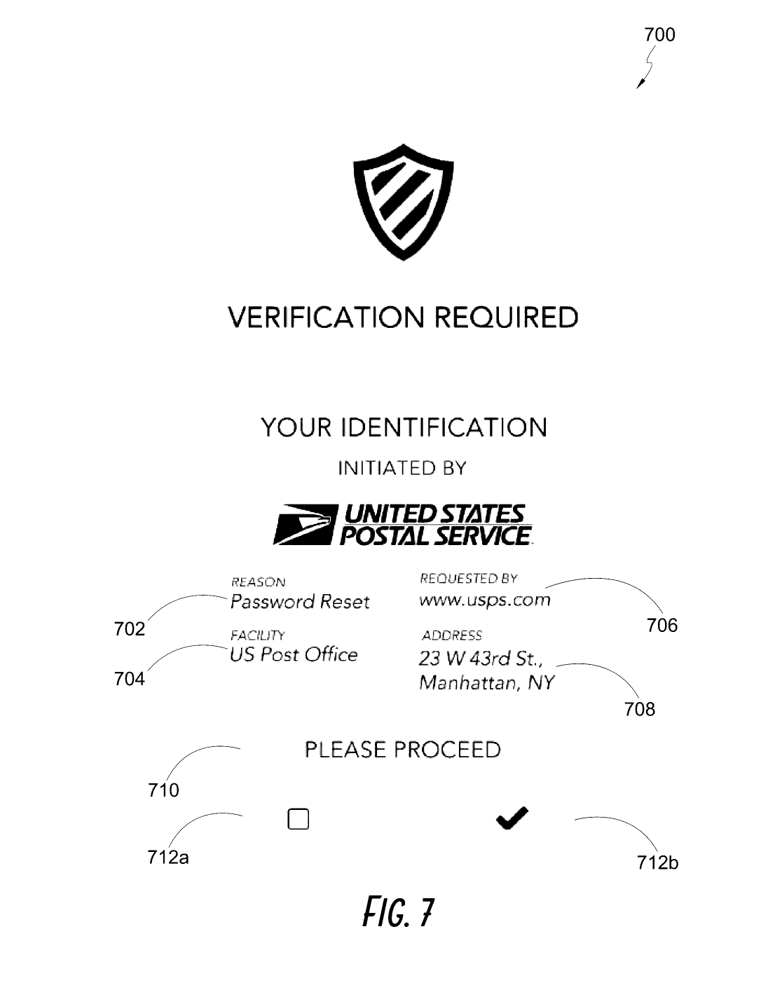

FIG. 7 shows a user interface displayed in some implementations of the disclosed methods and systems. The user interface 700 of FIG. 7 is a verification dialog for a password reset operation. In some aspects, the user interface 700 may be displayed on an electronic display of a user whose account is being administratively modified. In some aspects, instructions 508 of device 502a, which is one of the one or more servers 502 of FIG. 5A, may configure the processor 503 to cause the user interface 700 to be displayed on the electronic display. In some aspects, the processor 503 may download instructions to one of the client devices 508a-c that implement a program that causes the user interface 700 to be displayed. For example, the one or more servers 502 may download a java program or other browser plug-in to the client devices 508a-c that causes the user interface 700 to be displayed. In other aspects, a client device 508a-c may include a mobile application that includes instructions that configure a processor on the mobile device 508a-c to display the user interface 700.

The user interface 700 provides a reason indication 702, which indicates, in this example, the reason for the verification is that a password reset operation has been initiated. Other reasons are also contemplated. The user interface 700 also includes a facility indication, which shows that the password reset operation was initiated from a U.S. post office facility in this example. The user interface 700 also includes a requestor indication, which in the illustrated example indicates that the password reset was required via www.usps.com. The user interface 700 also includes an address indication 708, indicating the address of the facility shown in facility indication 704. The user interface 700 also includes a prompt 710, indicating that acknowledgment of the dialog/user interface 700 will allow the verification operation of the password reset to proceed. The user interface 700 also includes controls/buttons 712a-b, that allow the user to either deny the password reset operation (via control 712a) or allow the password reset to proceed (via control 712b).

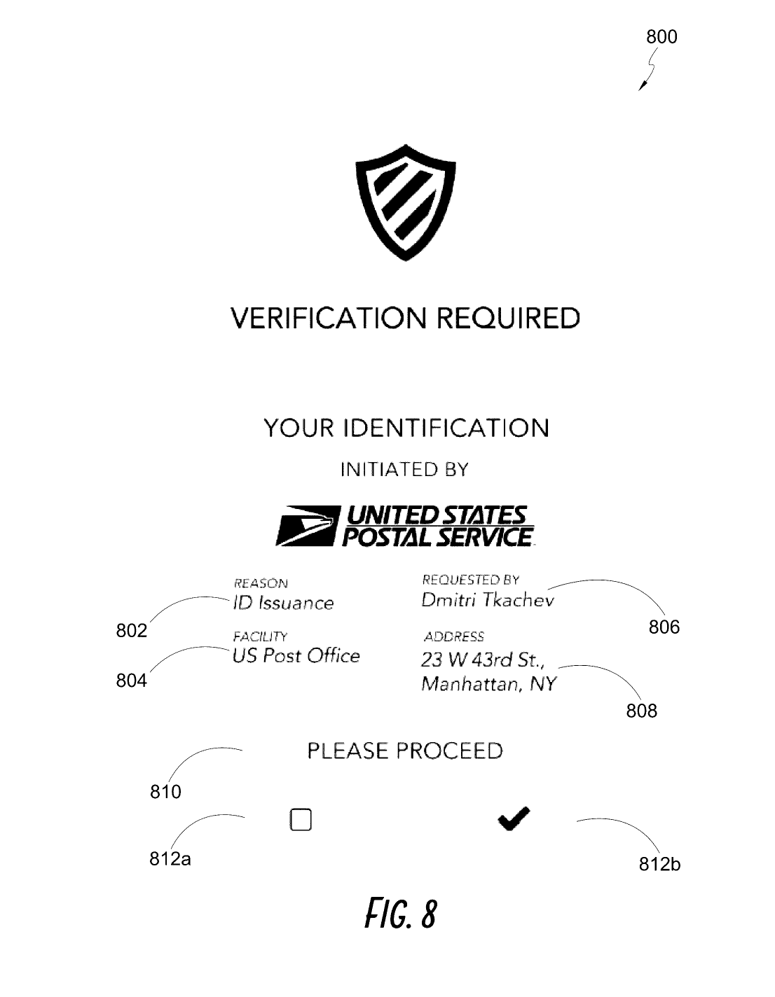

FIG. 8 shows a user interface displayed in some implementations of the disclosed methods and systems. The user interface 800 of FIG. 8 is a verification dialog for issuance of a personal identification, such as a driver's license, passport, or U.S. identification card. In some aspects, the user interface 800 may be displayed on an electronic display of a user with administrative privileges to a user's account which is the subject of the user interface 800. In some aspects, instructions 508 of device 502a, which is one of the one or more servers 502 of FIG. 5A, may configure the processor 503 to cause the user interface 800 to be displayed on the electronic display. In some aspects, the processor 503 may download instructions to one of the client devices 508a-c that implement a program that causes the user interface 800 to be displayed. For example, the one or more servers 502 may download a java program or other browser plug-in to the client devices 508a-c that cause the user interface 800 to be displayed. In other aspects, a client device 508a-c may include a mobile application that includes instructions that configure a processor on the mobile device 508a-c to display the user interface 800.

The user interface 800 indicates a reason indication 802, which indicates the reason for the verification is that someone is attempting to have an identification issued based on identification records that are administered by the user receiving the user interface 800. The user interface 800 also includes a facility indication, which shows that issuance of the identification was initiated from a U.S. post office facility in this example. The user interface 800 also includes a requestor indication, which in the illustrated example indicates that the identification is being requested by an individual named “Dmitri Tkachev.” The user interface 800 also includes an address indication 808, indicating the address of the facility shown in facility indication 804. The user interface 800 also includes a prompt 810, indicating that acknowledgment of the dialog/user interface 800 will allow the issuance of the identification to proceed. The user interface 800 also includes controls/buttons 812a-b. These controls allow the user to either deny the identification issuance operation (via control 812a) or allow the identification issuance to proceed (via control 812b).

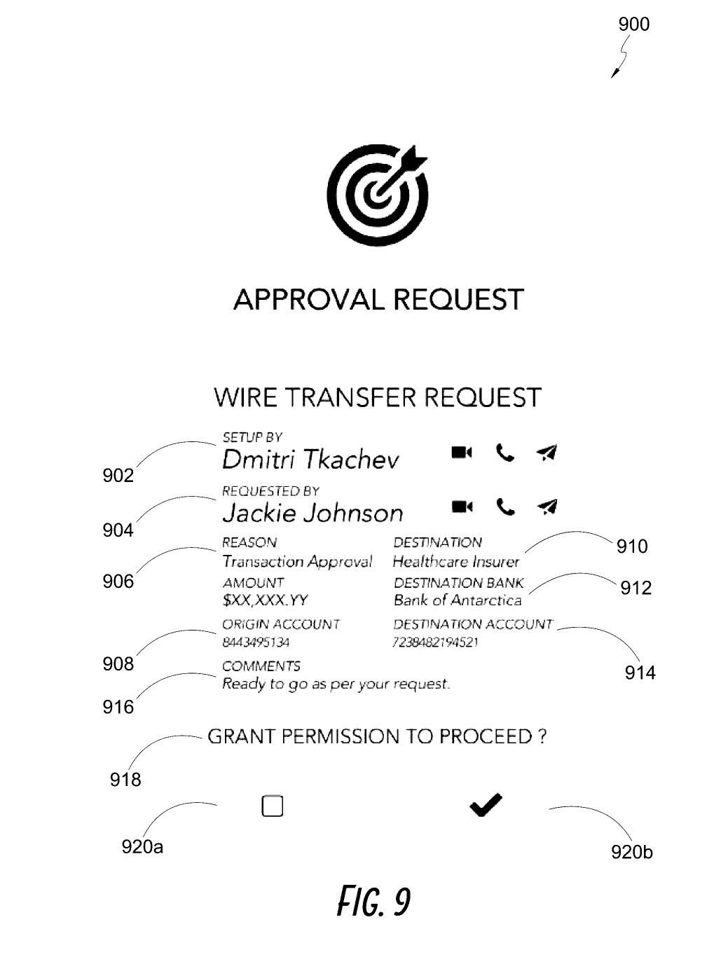

FIG. 9 shows a user interface displayed in some implementations of the disclosed methods and systems. In some aspects, the user interface 900 may be displayed on an electronic display of a user with administrative privileges to a user's account being used as a source of electronic funds for a wire transfer, which is a subject of the user interface 900. In some aspects, instructions 508 of device 502a, which is one of the one or more servers 502 of FIG. 5A, may configure the processor 503 to cause the user interface 900 to be displayed on the electronic display. In some aspects, the processor 503 may download instructions to one of the client devices 508a-c that implement a program that causes the user interface 900 to be displayed. For example, the one or more servers 502 may download a java program or browser plug-in to the client devices 508a-c that cause the user interface 900 to be displayed. In other aspects, a client device 508a-c may include a mobile application that includes instructions that configure a processor on the mobile device 508a-c to display the user interface 900.

The user interface 900 of FIG. 9 is an approval request dialog for a wire transfer from a user's account that is controlled by the methods and systems disclosed herein. The user interface 900 may be displayed on an electronic display associated with the user. For example, the user may be logged in using a terminal including the electronic display.

The user interface 900 includes an indication 902 of who “set up” the wire transfer request. The individual “setting up” the transfer request may be an administrative individual at a financial institution initiating the wire transfer. The user interface 900 also includes a requested by indication 904, indicating an individual who originally requested the wire transfer. The user interface 900 also includes a reason indication 906, indicating the reason for the approval request. In the illustrated example, the reason indication 906 indicates that the user interface 900 is being presented to the user to solicit approval of the wire transfer request. The user interface 900 also includes an amount indication 908, which indicates an amount of the wire transfer request. The user interface 900 also includes a destination indication 910, in this example indicating the destination of the money subject to the wire transfer. The user interface 900 also includes a destination bank indication, in this case the bank of Antarctica. The user interface 900 also includes a destination account indication 914. The user interface 900 also includes a comments indication 916. In the illustrated example, the comments indicate that the wire transfer is ready to go, and all that is needed is the approval by the individual receiving the user interface 900. A prompt 918 prompts the user for their permission to proceed with the wire transfer, and controls 920a-b receive either a negative approval (via control 920a) or an approval (via control 920b).

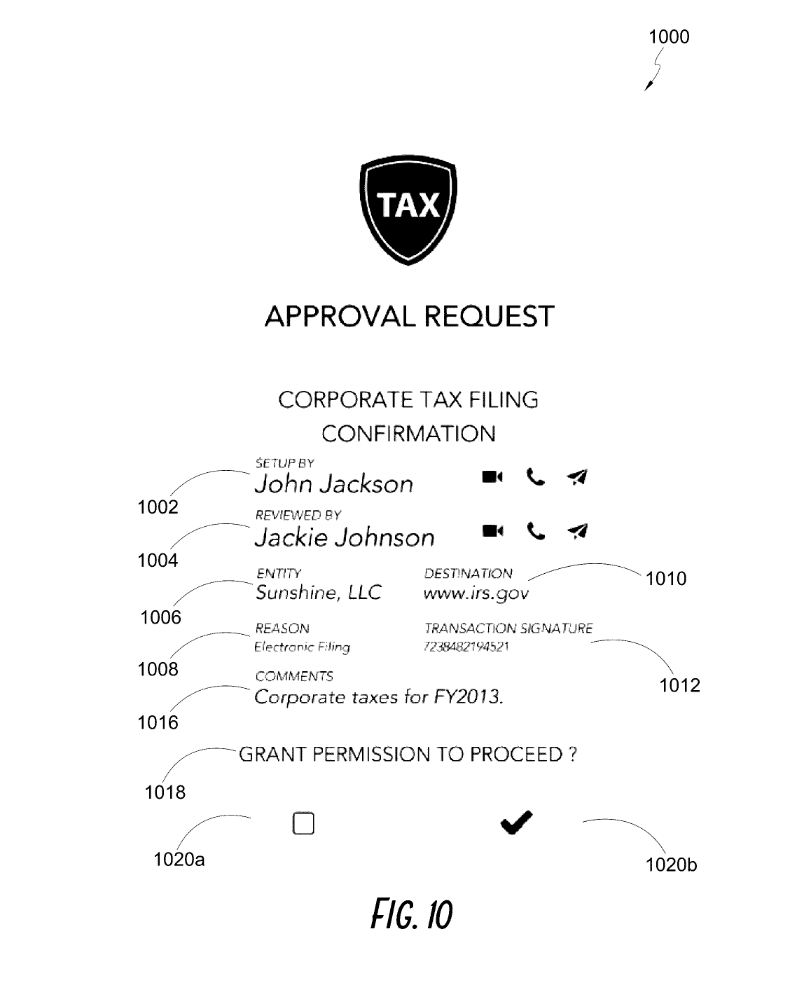

FIG. 10 shows a user interface displayed in some implementations of the disclosed methods and systems. The user interface 1000 of FIG. 10 is an approval request dialog for a corporate tax filing for a user that is managing a corporate account via the methods and systems disclosed herein. In some aspects, the user interface 1000 may be displayed on an electronic display of a user with administrative privileges to a user's account being used as a source for the corporate tax filing, which is a subject of the user interface 1000. Alternatively, the user interface 1000 may be displayed to a user associated with the corporation. In some aspects, instructions 508 of device 502a, which is one of the one or more servers 502 of FIG. 5A, may configure the processor 503 to cause the user interface 1000 to be displayed on the electronic display. In some aspects, the processor 503 may download instructions to one of the client devices 508a-c that implement a program that causes the user interface 1000 to be displayed. For example, the one or more servers 502 may download a java program or browser plug-in to the client devices 508a-c that cause the user interface 1000 to be displayed. In other aspects, a client device 508a-c may include a mobile application that includes instructions that configure a processor on the mobile device 508a-c to display the user interface 1000.

The user interface 1000 includes an indication 1002 of who “set up” the corporate tax filing. The individual “setting up” the transfer request may be an administrative individual at a financial institution initiating the corporate tax filing. The user interface 1000 also includes a “reviewed by” indication 1004, indicating an individual who has reviewed the corporate tax filing. The user interface 1000 also includes an entity indication 1006, indicating an entity for which the corporate tax filing applies. In the illustrated example, the corporate tax filing is for sunshine, LLC. The user interface 1000 also includes a reason indication, which indicates the reason for the corporate tax filing confirmation dialog. In the illustrated example, the reason is the electronic filing of the corporate taxes. The user interface 1000 also includes a destination indication 1010, indicating in this example that the corporate taxes are destined for the Internal Revenue Service website “www.irs.gov.” The user interface 1000 also includes a transaction signature 1012. The user interface 1000 also includes a comments indication 1016, which may be entered by either the “setup by” individual or the “reviewed by” individual. A default message may also be provided. The user interface 1000 also includes a prompt 1018, asking the user whether permission is granted for the corporate tax filing to proceed. Controls 1020a-b provide negative acknowledgment (via control 1020a) and permission (via control 1020b) for the corporate tax filing to occur.

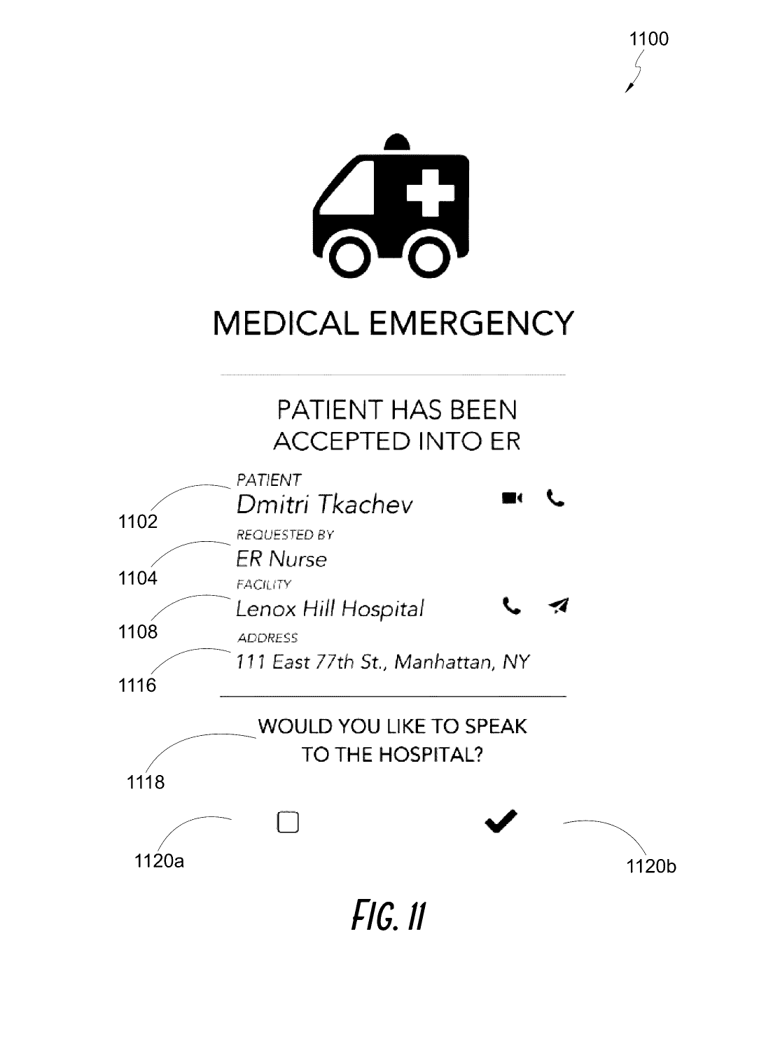

FIG. 11 shows a user interface displayed in some implementations of the disclosed methods and systems. The user interface 1100 of FIG. 11 is a notification that an individual (“patient’) has been accepted into an emergency room. In some aspects, the user interface 1100 may be displayed to a user that is designated as a guardian or other contact of the patient. In some aspects, in order for the dialog to be displayed to a particular user, the patient must grant prior permission for the user to receive such a notification.

In some aspects, instructions 508 of device 502a, which is one of the one or more servers 502 of FIG. 5A, may configure the processor 503 to cause the user interface 1100 to be displayed on the electronic display. In some aspects, the processor 503 may download instructions to one of the client devices 508a-c that implement a program that causes the user interface 1100 to be displayed. For example, the one or more servers 502 may download a java program or browser plug-in to the client devices 508a-c that cause the user interface 900 to be displayed. In other aspects, a client device 508a-c may include a mobile application that includes instructions that configure a processor on the mobile device 508a-c to display the user interface 1100.

The user interface 1100 includes a patient indicator 1102, in this case indicating the patient's name is “Dmitri Tkachev.” The user interface 1100 also includes a “requested by” indicator 1104. In the illustrated example, the alert provided by user interface 1100 was requested by an emergency room nurse. The user interface 1100 also includes a facility indicator 1108. In the illustrated example, the facility is the “Lenox Hill Hospital.” An address indicator 1116 indicates the location of the facility where the patent was accepted into the emergency room. A prompt 1118 asks the user viewing the user interface 1100 whether they would like to speak directly with the hospital indicated by the facility indicator 1108. The user can deny the request to speak to the hospital via control 1120a or accept the request to speak to the hospital via control 1120b. If the user selects control 1120b, and the user interface 1100 is being displayed on a computer that is able to control a phone system, such as a cell phone, desk phone, or even a virtual IP phone running on a personal computer or tablet, then selecting control 1120b may cause a telephone call to be placed to the hospital or facility indicated by facility indicator 1108.

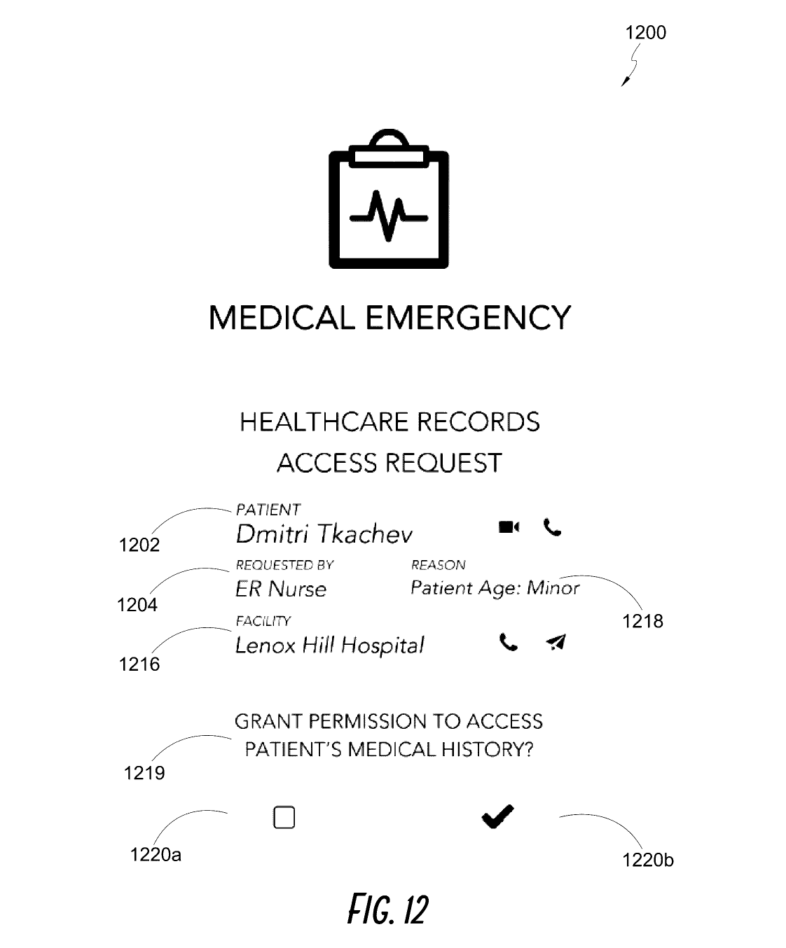

FIG. 12 shows a user interface displayed in some implementations of the disclosed methods and systems. The user interface 1200 of FIG. 12 is a request to access a patient's medical records in an emergency situation. In some aspects, the user interface 1200 may be displayed to a user that is designated as a guardian or other contact of the patient. In some aspects, in order for the dialog to be displayed to a particular user, the patient must grant prior permission for the user to receive such a notification/request.

In some aspects, instructions 508 of device 502a, which is one of the one or more servers 502 of FIG. 5A, may configure the processor 503 to cause the user interface 1200 to be displayed on the electronic display. In some aspects, the processor 503 may download instructions to one of the client devices 508a-c that implement a program that causes the user interface 1200 to be displayed. For example, the one or more servers 502 may download a java program or browser plug-in to the client devices 508a-c that cause the user interface 1200 to be displayed. In other aspects, a client device 508a-c may include a mobile application that includes instructions that configure a processor on the mobile device 508a-c to display the user interface 1200.

The user interface 1200 includes a patient indicator 1202, in this case indicating the patient's name is “Dmitri Tkachev.” The user interface 1200 also includes a “requested by” indicator 1204. In the illustrated example, the alert provided by user interface 1200 was requested by an emergency room nurse. The user interface 1200 also includes a facility indicator 1216. In the illustrated example, the facility is the “Lenox Hill Hospital.” The user interface 1200 also includes a reason indication 1218, indicating the reason for the healthcare records access request is that the patient is a minor. A prompt 1219 asks the user viewing the user interface 1200 whether they grant permission for the facility indicated by facility indicator 1216 to access the heath care records of the patient indicated by patient indicator 1202. The user can deny the request to access the healthcare records via control 1220a or accept the request to access the health care records via control 1220b.

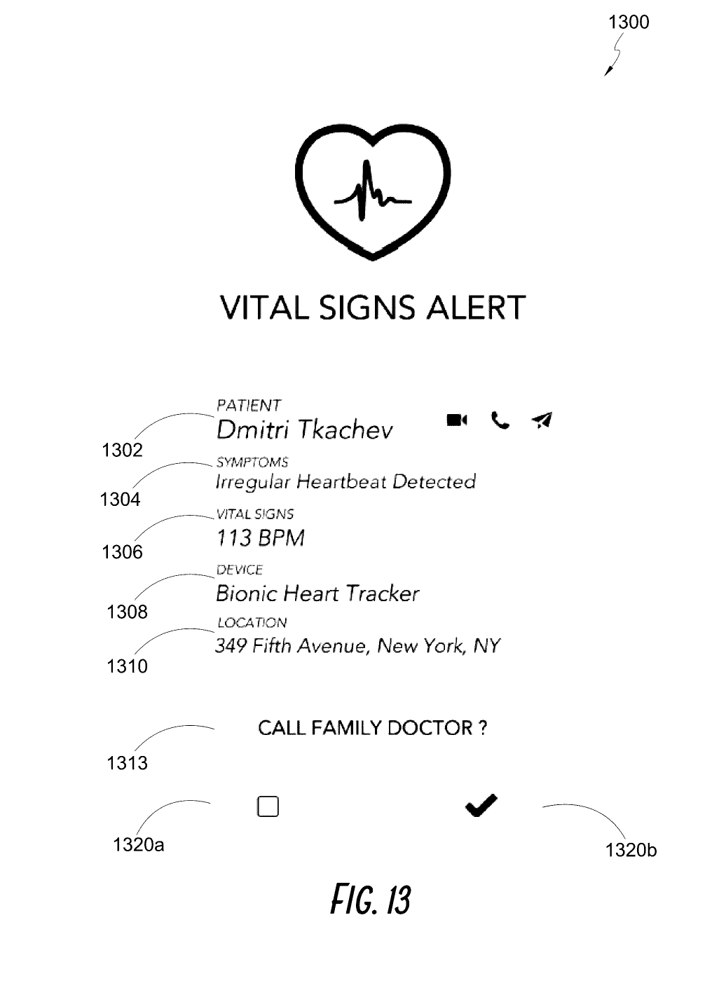

FIG. 13 shows a user interface displayed in some implementations of the disclosed methods and systems. The user interface 1300 of FIG. 13 is a vital signs alert. In some aspects, the user interface 1300 may be displayed to a user that is designated as a guardian or other contact of the patient. In some aspects, in order for the dialog to be displayed to a particular user, the patient must grant prior permission for the user to receive such a notification/request. In some other aspects, the user interface 1300 may be displayed to the patient themselves.

In some aspects, instructions 508 of device 502a, which is one of the one or more servers 502 of FIG. 5A, may configure the processor 503 to cause the user interface 1300 to be displayed on the electronic display. In some aspects, the processor 503 may download instructions to one of the client devices 508a-c that implement a program that causes the user interface 1300 to be displayed. For example, the one or more servers 502 may download a java program or browser plug-in to the client devices 508a-c that cause the user interface 1300 to be displayed. In other aspects, a client device 508a-c may include a mobile application that includes instructions that configure a processor on the mobile device 508a-c to display the user interface 1300.

The user interface 1300 includes a patient indicator 1302, in this case indicating the patient's name is “Dmitri Tkachev.” The user interface 1300 also includes a symptoms indicator 1304. In the illustrated example, the symptoms are indicated to be an irregular heartbeat. The user interface 1300 also includes a vital signs indicator 1306. In the illustrated example, the vital signs being shown are the heart rate, at 113 beats per minute (BPM). In some aspects, other vital signs may be shown, such as a respiration rate, a body temperature, blood pressure, blood oxygen saturation, blood sugar level, and/or an indication of convulsive activity. The user interface 1300 also includes a device indication 1308. The device indication indicates a device generating the vital signs alert, in the illustrated example, the device is a bionic heart tracker. The user interface 1300 also include a location indication 1310, indicating the location where the patient was located when the vital signs alert was generated. A prompt 1313 asks the user seeing the user interface 1300 whether a family doctor should be called. The user can deny the request to call the family doctor via control 1320a or accept the request to call the family doctor via control 1320b. If the user selects control 1320b, and the user interface 1300 is being displayed on a computer that is able to control a phone system, such as a cell phone, desk phone, or even a virtual IP phone running on a personal computer or tablet, then selecting control 1320b may cause a telephone call to be placed to the hospital or facility associated with the family doctor.

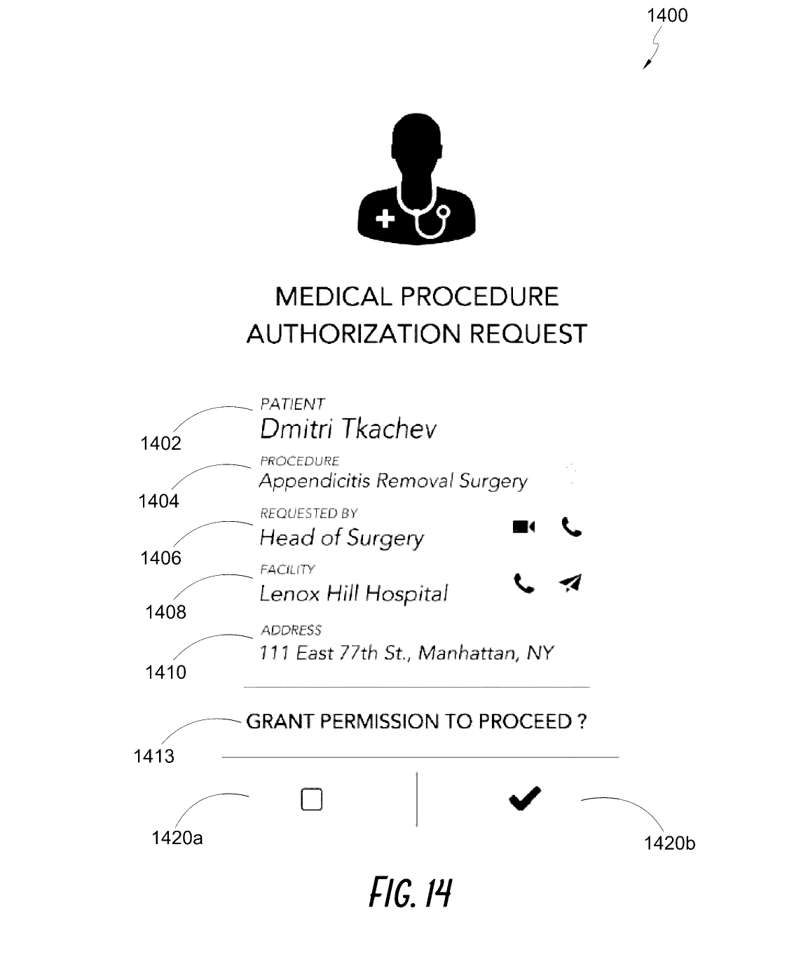

FIG. 14 shows a user interface displayed in some implementations of the disclosed methods and systems. The user interface 1400 of FIG. 14 is a medical procedure authorization request. In some aspects, the user interface 1400 may be displayed to a user that is designated as a guardian or other contact of the patient. In some aspects, in order for the dialog to be displayed to a particular user, the patient must grant prior permission for the user to receive such a notification/request. In some other aspects, the user interface 1400 may be displayed to the patient themselves.

In some aspects, instructions 508 of device 502a, which is one of the one or more servers 502 of FIG. 5A, may configure the processor 503 to cause the user interface 1400 to be displayed on the electronic display. In some aspects, the processor 503 may download instructions to one of the client devices 508a-c that implement a program that causes the user interface 1400 to be displayed. For example, the one or more servers 502 may download a java program or browser plug-in to the client devices 508a-c that cause the user interface 1400 to be displayed. In other aspects, a client device 508a-c may include a mobile application that includes instructions that configure a processor on the mobile device 508a-c to display the user interface 1400.

The user interface 1400 includes a patient indicator 1402, in this case indicating the patient's name is “Dmitri Tkachev.” The user interface 1400 also includes a medical procedure indicator 1404, indicating the type of medical procedure for which the request for authorization pertains. In the illustrated example, the procedure for which authorization is being requested is an appendicitis removal surgery. The user interface 1400 also includes a requested by indication 1406, in the illustrated example, the authorization request is being requested by the head of surgery. The user interface 1400 also includes a facility indication 1408. In the illustrated example, the facility is the “Lenox Hill Hospital.” The user interface 1400 also includes an address indicator 1410, indicating the address of the facility indicated by indicator 1408. A prompt 1413 asks the user whether permission to perform the procedure indicated by procedure indicator 1404 is granted. By selecting control 1420a, the user can deny the request to perform the procedure. By selecting control 1420b, the user can approve the request to perform the procedure.

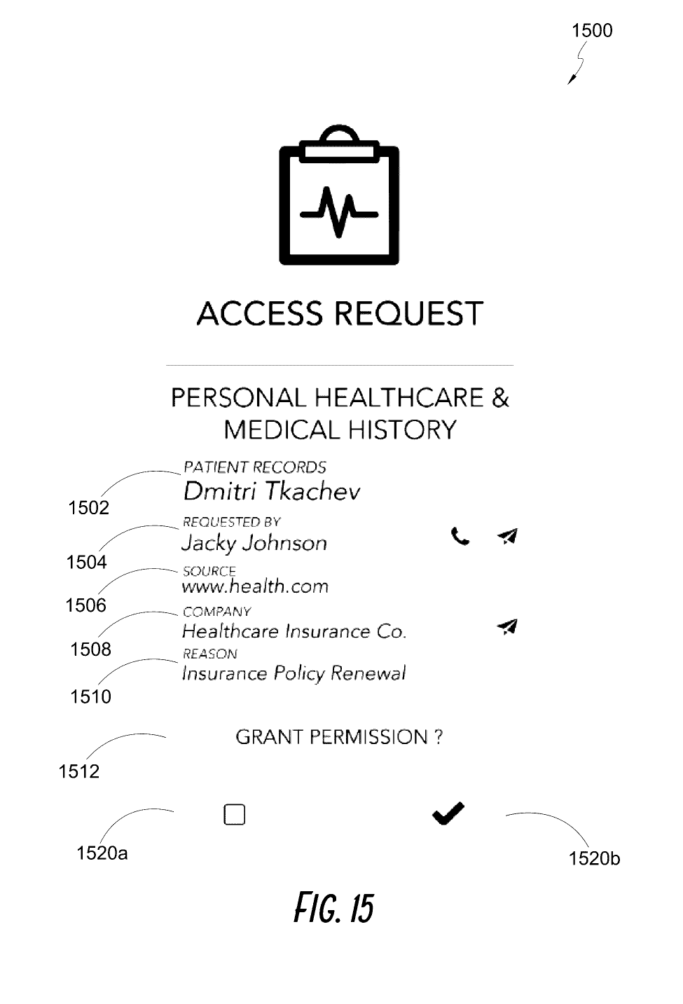

FIG. 15 shows a user interface displayed in some implementations of the disclosed methods and systems. The user interface 1500 of FIG. 15 is a personal healthcare and medical history access request. In some aspects, the user interface 1500 may be displayed to a user that is designated as a guardian or other contact of a patient. In some aspects, in order for the dialog to be displayed to a particular user, the patient must grant prior permission for the user to receive such a notification/request. In some other aspects, the user interface 1500 may be displayed to the patient themselves.

In some aspects, instructions 508 of device 502a, which is one of the one or more servers 502 of FIG. 5A, may configure the processor 503 to cause the user interface 1500 to be displayed on the electronic display. In some aspects, the processor 503 may download instructions to one of the client devices 508a-c that implement a program that causes the user interface 1500 to be displayed. For example, the one or more servers 502 may download a java program or browser plug-in to the client devices 508a-c that cause the user interface 1500 to be displayed. In other aspects, a client device 508a-c may include a mobile application that includes instructions that configure a processor on the mobile device 508a-c to display the user interface 1500.

The user interface 1500 includes a patient records indicator 1502, in this case indicating the patient's name is “Dmitri Tkachev.” The user interface 1500 also includes a “requested by” indicator 1504, indicating an individual who is requesting access to the personal healthcare and medical history information. The user interface 1500 also includes a source indicator 1506, indicating a source of the personal healthcare and medical history information. In this example, www.health.com is indicated, which may be a HIE or HISP as discussed above. The user interface 1500 also includes a company indicator 1508, which indicates an entity that is requesting access to the personal healthcare and medical history. A reason indication is also provided on user interface 1500, which indicates a reason for the access request. In this illustrated example, an insurance policy is being renewed, and perhaps the insurance company needs to review personal healthcare and medical history before renewing the policy. A prompt 1512 asks the user to which the user interface 1500 is displayed whether they grant permission for the company to access the personal healthcare and medical history of the patient. The request for access can be denied via selection of control 1520a and approved via selection of control 1520b.

FIG. 16 is a flowchart of a method 1600 for prompting for authorization to access health care information that may be implemented in at least some of the disclosed embodiments. In some aspects, the method may be implemented by one or more of the servers 502 shown in FIG. 5A. In some aspects, the method may be implemented by a combination of the one or more servers 502 of FIG. 5A, along with one of the client devices 508a-c. In some aspects, the method 1600 may implement one or more of the user interfaces shown in FIGS. 6A-15. For example, the method 1600 may implement one or more of the user interfaces described with respect to FIGS. 6A-B, 12, and/or 15. In some aspects, the method 1600 provides a method for access to healthcare information by a specific third party following approval by an individual designated to maintain access to the healthcare information. In some aspects, the designated individual may be the individual to which the healthcare information pertains. In other aspects, the designated individual may be a parent or guardian of an individual to which the health care information pertains.

In block 1605, healthcare information is received for an individual. For example, the healthcare information may be received by a system implemented by the one or more servers 502 discussed above. In some aspects, the healthcare information received in block 1605 may include one or more of family history information, identification information, such as name, social security number, address, driver license numbers, passport numbers identification numbers, and the like. The healthcare information may also include one or more of information relating to one or more medical procedures performed on the individual in the past, records relating to one or more medical evaluations performed in the past. For example, this information might include vital signs recorded during the medical evaluations and or procedures, and/or conclusions or recommendations of medical professionals performing the evaluations and/or procedures.

In some aspects, the healthcare information may be received by the one or more servers 502 over a computer network, such as the Internet. In some aspects, the one or more servers 502 may implement a web based user interface that is displayed on one of the client devices 508a-c shown in FIG. 5A. The web based user interface may include one or more screens that allow entry of the healthcare information. After the information is submitted via the web user interface, the healthcare information may be received by the one or more servers 502 and stored in the database 504.

In block 1610, electronic contact information is received. The electronic contact information may be received, in some aspects, by the system implemented by the one or more servers 502 discussed above. In some aspects, the electronic contact information may be received over a computer network, such as the Internet. The electronic contact information may include one or more of email address(es), phone number(s), fax number(s), skype identifiers, instant messaging user names, twitter account identification information, and the like. In some aspects the electronic contact information relates to the individual themselves. For example, if healthcare information for John Doe is received in block 1605, then contact information for John Doe is received in block 1610. In some other aspects, the contact information received in block 1610 may be for a different individual than John Doe, in the example above. For example, in some aspects, the contact information received in block 1610 may be for an individual designated as a guardian or parent of the individual whose healthcare information was received in block 1605. The electronic contact information received in block 1610 may be contact information for an individual that will receive notifications when health care information for the individual discussed with respect to block 1605 is accessed or modified. In some aspects, the electronic contact information may be for a second individual with approval authority for medical procedures that may be performed on the individual referenced in block 1605.

In block 1615, a request to access the healthcare information is received. In some aspects, the request is received via a web user interface implemented by the one or more servers 502 shown in FIG. 5A. In some aspects, the request may be received via a service oriented interface (not shown) provided by the one or more servers 502.

In some aspects, as shown in FIG. 6A, the access request received in block 1615 may be part of a request to transfer the healthcare information from the one or more servers 502 to an entity shown by the destination indicator 607 shown in FIG. 6A. In some other aspects, as shown in FIG. 6A, the access request may be part of a data transfer operation to a third party provider of healthcare services, as shown by the indicators 656 and 658 of FIG. 6B. Alternatively, in some aspect, the request for access may be for personal healthcare and medical history information to facilitate renewal of an insurance policy, as shown by indicators 1508-1510 of FIG. 15. In some aspects, the access request includes one or more of an identification of a requestor, identification of a scope of access requested for the healthcare information, an identification of an amount of time and/or amount of data for which access is requested, and/or whether read and/or write access to the healthcare information is requested.

In block 1620, a prompt for approval of the access request is generated. The prompt may be generated based on the contact information received in block 1610. In some aspects, the prompt may take substantially the form of one of the user interfaces shown in FIG. 6A-B, 12 or 15. In some aspects, the prompt may include one or more of information relating to who “set up” the access request, a requestor of the access request, a reason for the access request, a destination of information to be accessed by the access request, IP address information relating to the access request, such as source and/or destination IP address information, comments relating to the access request, information identifying a service relating to the access request, a database IP address relating to the access request, a patient name relating to the access request. In some cases, the patient may be the individual whose healthcare information was received in block 1605, a facility from which the access request was generated, and/or a reason for the access request.

In block 1625, input is received indicating whether the access request is approved. In some aspects, the input is received over a computer network, such as the Internet. In some aspects, the input is received from a user interface control on one of the user interfaces shown in FIG. 6A-B, 12, or 15. For example, any one of controls 614a-b, 664a-b, 1220a-b, and 1520a-b may generate the input received in block 1625.

In block 1630, access to the health care information is conditionally allowed based on the input. For example, if the input indicates access should be allowed, then block 1620 may allow access. In some aspects, any one of the controls 614b, 664b, 1220b, and 1520b may generate input indicating access should be allowed. In some aspects, allowing access may include generating a security credential or token that may be used to obtain access to the requested healthcare information.

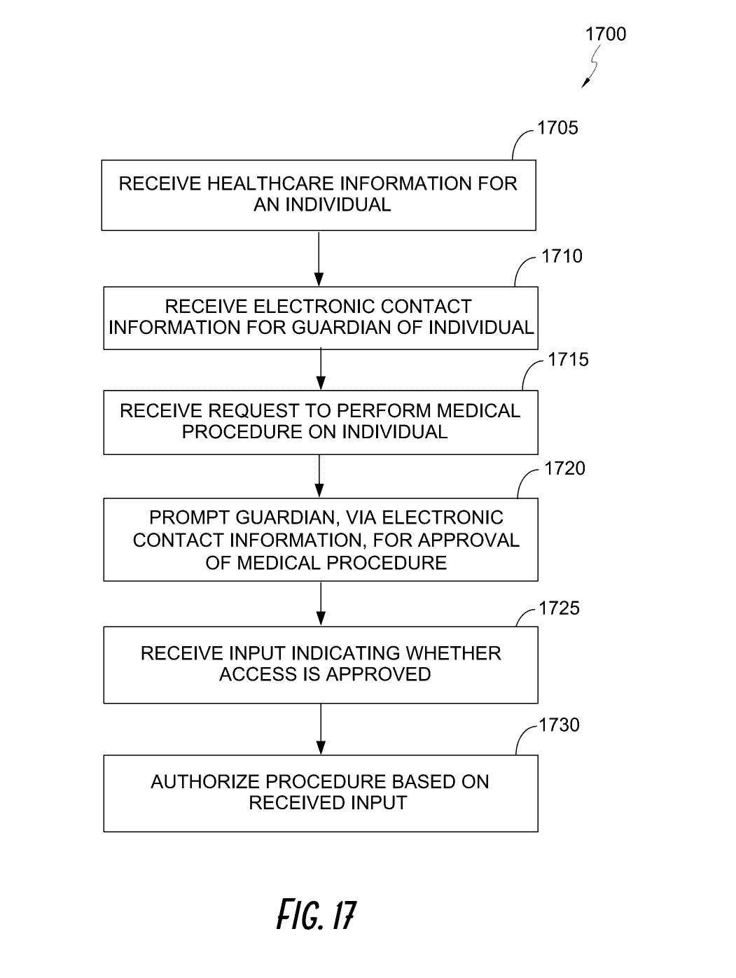

FIG. 17 is a flowchart of a method 1700 of prompting for authorization for a medical procedure to be performed. Method 1700 that may be implemented in at least some of the disclosed embodiments. In some aspects, the method may be implemented by one or more of the servers 502 shown in FIG. 5A. For example, the electronic hardware memory 504 of the servers 502 may store instructions 508 that configure the electronic hardware processor 503 to perform one or more of the functions discussed below with respect to FIG. 17.

In some aspects, the method may be implemented by a combination of the one or more servers 502 of FIG. 5A, along with one of the client devices 508a-c. In some aspects, the method 1700 may implement one or more of the user interfaces shown in FIGS. 6A-15. For example, the method 1700 may implement the user interface 1400 shown in FIG. 14 in some aspects. The method 1700 provides a way for a guardian of an individual, or in some aspects, a second individual who is at least associated with the individual in some capacity, to approve a particular medical procedure to be performed on an individual via a computer based interface. In some aspects, authorization to perform the procedure may also automatically cause the procedure to be applied. For example, in some aspects, the authorization may cause a medical device, such as an infusion pump, x-ray machine, a proton therapy machine, to capture an image or begin a treatment regime for example. By using method 1700, the time required for a health care professional to identify which individual is authorized to provide such approval, their current contact information, and make personal contact with the individual is greatly reduced. This time saved may be the difference between a positive or negative outcome for the patient concerned.

In block 1705, healthcare information is received for an individual. In some aspects, the healthcare information received in block 1705 may include one or more of family history information, identification information, such as name, social security number, address, driver license numbers, passport numbers identification numbers, and the like. The healthcare information may also include one or more of information relating to one or more medical procedures performed on the individual in the past, records relating to one or more medical evaluations performed in the past. For example, this information might include vital signs recorded during the medical evaluations and or procedures, and/or conclusions or recommendations of medical professionals performing the evaluations and/or procedures.

The healthcare information may be received over a computer network, such as the Internet in some aspects. In some aspects, the one or more servers 502 may implement a web based user interface that is displayed on one of the client devices 508a-c shown in FIG. 5A. The web based user interface may include one or more screens that allow entry of the healthcare information. After the information is submitted via the web user interface, the healthcare information may be received by the one or more servers 502, as described with respect to block 1705, and stored in the database 504.

In block 1710, electronic contact information for a guardian of an individual is received. In some aspects, the electronic contact information may be one or more of an email address, phone number, instant messaging user name, twitter account identifier, or the like. In some aspects, the electronic contact information may be a user name of the guardian within an electronic healthcare records system, such as the system implemented by the one or more servers 502 illustrated in FIG. 5A. In some aspects, the contact information may be for one or more individuals associated with the individual. For example, the contact information may be for a mother, father, wife, sibling such as a brother or a sister, or a significant other. In some aspects, implicit in the reception of this information is an authorization to allow the associated individual to approve medical decisions on behalf of the individual. This may include medical decisions relating to access to medical information, or other decisions such as approval of medical treatment in the event the individual is incapacitated or otherwise unable to provide informed consent for such decisions.

In block 1715, a request to perform a medical procedure on an individual is received. In some aspects, the request received in block 1715 may be in the form of a network message received by the system 502a, discussed above with respect to FIGS. 5A-B. In some aspects, the network message may be generated, as discussed above, by an electronic device controlled by a healthcare professional. For example, in some aspects, a doctor or nurse may indicate the need to perform the medical procedure on the electronic device 508a, discussed above with respect to FIG. 5A. The network message may be received by the device 502, also illustrated in FIG. 5A, an embodiment of which is provided in detail as device 502a of FIG. 5B.

In some aspects, the request of block 1715 is generated on the device 502a from a web based or mobile application based user interface provided to the healthcare professional. In some aspects, the interface may allow the healthcare professional to select an identification of the individual, for example, by their name, social security number, user name within the system of servers 502, or other identifying information. The web based or mobile application may be configured to display its user interface on the device 508a for example. After the health care professional enters the treatment information on the device 508a, the information and the request may be received by the server 502.

The device 502 may then automatically identify appropriate contact information for the guardian of the individual, for example, based on the electronic contact information received in block 1710. An association between the individual and one or more guardians or associated individuals may be stored in the database 504, and retrieved by device 502 in response to the request.

In block 1720, a prompt is generated for the guardian, using the electronic contact information. The prompt requests approval to perform the medical procedure. For example, in some aspects, the prompt may substantially take the form of user interface 1400 shown in FIG. 14. As shown, the prompt may indicate one or more of the patient name, the procedure for which approval is requested, a name and/or title of an individual requesting the approval, a facility at which the subject procedure will be performed, and an address of the facility at which the procedure will be performed. In some aspects, generating a prompt may include transmitting one or more messages over a computer network, the one or more messages defining the prompt. For example, in some aspects, generating a prompt may include transmitting a hypertext transfer protocol (http) response to an http get request, the response defining the prompt. In some other aspects, generating a prompt may comprise transmitting instructions over a computer network that configure a receiving computer to generate the prompt, for example, in the case of downloading instructions for a browser plug-in or other client based application to execute. In some aspects, generating a prompt may include device 502 of FIG. 5A generating a network message defining the prompt (such as an http message including html, xml, or the like), and sending the network message to a personal electronic device of the guardian, such as device 508b of FIG. 5A.

In block 1725, input is received indicating whether the procedure is approved. In some aspects, the received input may be received over a computer network, for example, via one or more http messages from a web based user interface. In some aspects, the input may be received from an application running on one of the client devices 508a-c shown in FIG. 5. The input may be received for example, indirectly from user interface controls 1420a or 1420b, indicating the permission is either not approved or approved respectively. For example, the personal electronic device of the guardian, for example, client device 508b of FIG. 5A, may generate a network message which is received as the input by the device 402 of FIG. 5A. The generated network message may include an indication of whether the procedure is approved. For example, the input may be in the form of an http post command in some aspects.

In block 1730, the procedure is authorized based on the received input. In some aspects, authorizing the procedure may include displaying a message on a user interface for the health care professional requesting authentication in block 1715. For example, in some aspects, the health care professional may be logged into the system implemented by the one or more servers 502 of FIG. 5 as a particular user. Block 1730 may cause an interface for the particular user to indicate the procedure is either approved or not approved based on the input. In addition, indications of the input received in block 1725 may be recorded in a record of the individual's health care information, including other details such as the date, time, confirmation code, and guardian name approving or disapproving the procedure.

In some aspects, authorizing the procedure may include sending one or more application programming interface (API) commands to medical equipment based on the authorization. In some aspects, the medical equipment may be configured to provide at least one aspect of the procedure to the individual upon approval. For example, the medical equipment may comprise a medical device, such as an infusion pump, x-ray machine, proton therapy machine, defibrillator, or other medical device capable of treating a patient such as the individual.

The medical equipment may administer at least a portion of the medical procedure in response to receiving the command. For example, if the input of block 1725 indicates the procedure is authorized, block 1730 may send commands to an infusion pump to begin administering a particular substance to the patient. The infusion pump may be accessible via the network 506 shown in FIG. 5A. For example, identifying information for the infusion pump may be stored in the database 504, and associated with records for the individual in the database 504.

When the procedure is authorized, the device 502 may look-up the identifying information for the infusion pump in the database 504, and send one or more commands to implement the procedure. For example, the device 502 may, in response to the authorization, first set a flow rate for the infusion pump using a first network API command. The first network API comment may be transmitted from the computer 502 to the infusion pump over a network. The device 502 may then send a second different API command to the infusion pump, indicating the pump should begin administering the substance, such as a drug, at the previously indicated flow rate. This second API command may also be transmitted in the form of a network message from the computer 502 to the infusion pump in some aspects. In response to receiving the second command, the infusion pump may provide power to a pump. The pump may create a suction on a first port and pressure to a second port. The first port may be connected to a supply reservoir, for example, of a medicine, saline, or other liquid. The second port may be connected, indirectly, to the individual. For example, the second port may be connected via an intravenous needle inserted into the individual, for example, into the individual's arm, hand, or abdomen.

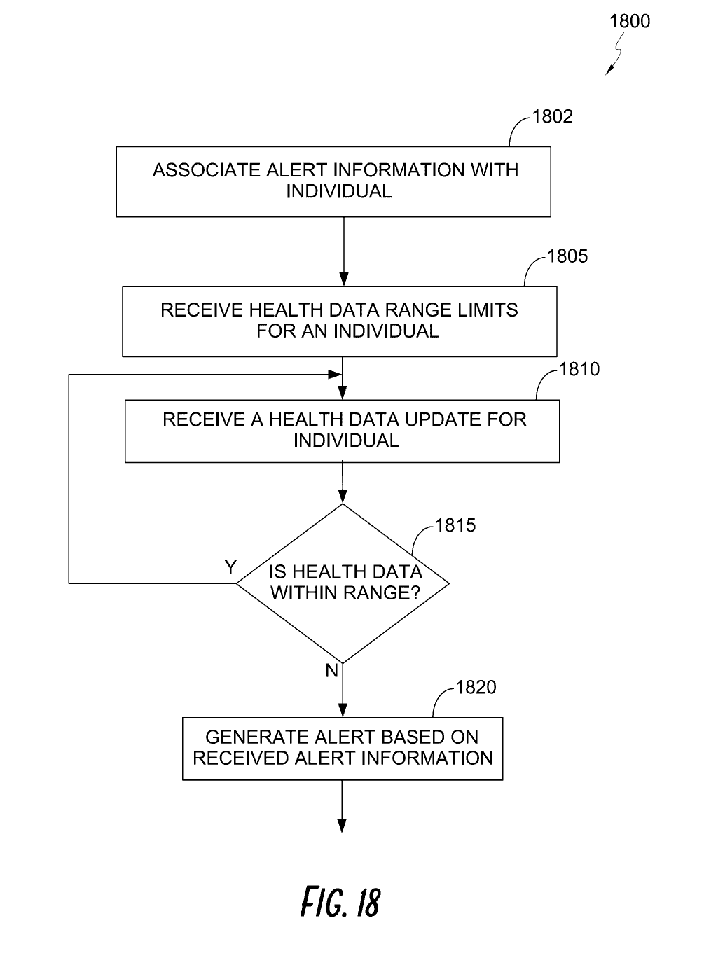

FIG. 18 is a flowchart of a method of alerting based on health information. Method 1800 that may be implemented in at least some of the disclosed embodiments. In some aspects, the method may be implemented by one or more of the servers 502 shown in FIG. 5A. In some aspects, the method may be implemented by a combination of the one or more servers 502 of FIG. 5A, along with one of the client devices 508a-c. In some aspects, the method 1800 may implement one or more of the user interfaces shown in FIGS. 6A-15. For example, the method 1800 may implement the user interface 1300 shown in FIG. 13 in some aspects. The method 1800 generates alerts when heath data falls outside of preset range limits. Thus, for example, a patient, doctor, or guardian may estimate limits for one or more vital signs of the patient. One or more devices may monitor the vital signs of the patient and periodically, or asynchronously provide updated vital sign information to a device performing method 1800. If the updated vital signs are not within the limits, then alerts may be generated. Such a system may ensure that interested parties are always kept up to date on a patient's vital signs. When vital signs indicate a problem, medical attention may be rendered more quickly than might otherwise occur in convention systems.

In block 1802, alert information is associated with an individual. In some aspects, block 1802 includes receiving alert contact information for a particular individual. For example, the alert contact information may include one or more of email address(es), phone numbers, instant message user names, a user name within the system implemented by the one or more servers 502 of FIG. 5, etc. In some aspects, multiple sets of alert information may be received for an individual. For example, an individual may have multiple other individuals and/or users that wish to receive alert information for the individual. For example, multiple members of an individual's family may be interested in receiving alert information. In some aspects, members of the individual's family, as well as one or more health care professionals may be interested in receiving the alerts. In some aspects, one or more of an individual's family, health care professionals, and/or a guardian for the individual may be interested in receiving alerts. Thus, in some aspects for example, multiple user names may be received in block 1802, and associated with the individual. The multiple user names identify users of the system implemented by the one or more servers 502 of FIG. 5.

In block 1805, one or more health data range limits are received for an individual. In some aspects, the range limits may be for a heart rate, blood pressure, body temperature, respiration rate, blood sugar level, blood oxygen saturation, or other diagnostic information measured from the individual. The range limits may indicate both a lower and upper limit, or just either a upper or lower limit.

In block 1810, a health data update is received. In some aspects, a health data update may be received in block 1810 periodically, or at random intervals. For example, in some aspects, a device generating health data updates may generate the updates periodically, or only when the health data changes by some constant or percentage amount. Some devices may generate updates when an amount of change is greater than a threshold or after a predetermined period of time has elapsed since the last update. The health data update may indicate measurements of one or more vital signs, such as the vital signs described above with respect to block 1805.

Decision block 1815 determines whether the health data received in block 1810 is within the ranges received in block 1805. In some aspects, block 1815 determines whether the update indicates data that is between an upper and lower limit for a vital sign, or whether the data is outside the range defined by an upper and lower limit.

If no upper limit is specified for a particular vital sign, decision block 1815 may not consider whether a vital sign is above any limit, but may instead only consider whether the vital sign is below a limit. Similarly, if no lower limit is specified for a particular vital sign, decision block 1815 may not consider whether the vital sign is below a limit, but instead only consider whether the vital sign is above a specified limit.

If decision block 1815 determines that the health data is within range, process 1800 returns to block 1810 and may receive additional updates to the health data. If decision block 1815 determines at least one vital sign in the health data is not within range, process 1800 moves to block 1820 and generates an alert based on the alert information received in block 1802.

In some aspects, block 1820 may generate an alert by displaying a version of the user interface 1300 shown in FIG. 13. In some aspect, generating the alert may include determining one or more sets of contact information associated with the individual. As discussed above, each individual may have one or more individuals with interest in their vital sign information, such as family members and/or medical healthcare professionals and/or guardians. Block 1820 may determine the contact information for each of these associated individuals and alert each of the individuals based on the contact information. In some aspects, alerting an individual may include one or more of generating an email, text message, instant message, phone call, or pop-up dialog on a display of the individual. In some aspects, the contact information includes a user name or identified for a user for individuals who should be contacted. Based on the user name, an alert may be generated via the system implemented by the servers 502 so as to cause a dialog box or other user interface element to appear on the display of the user. For example, the user interface 1400, or a user interface substantially similar to user interface 1300, may be shown on a display associated with a user name or other user identifier of a user associated with the individual.

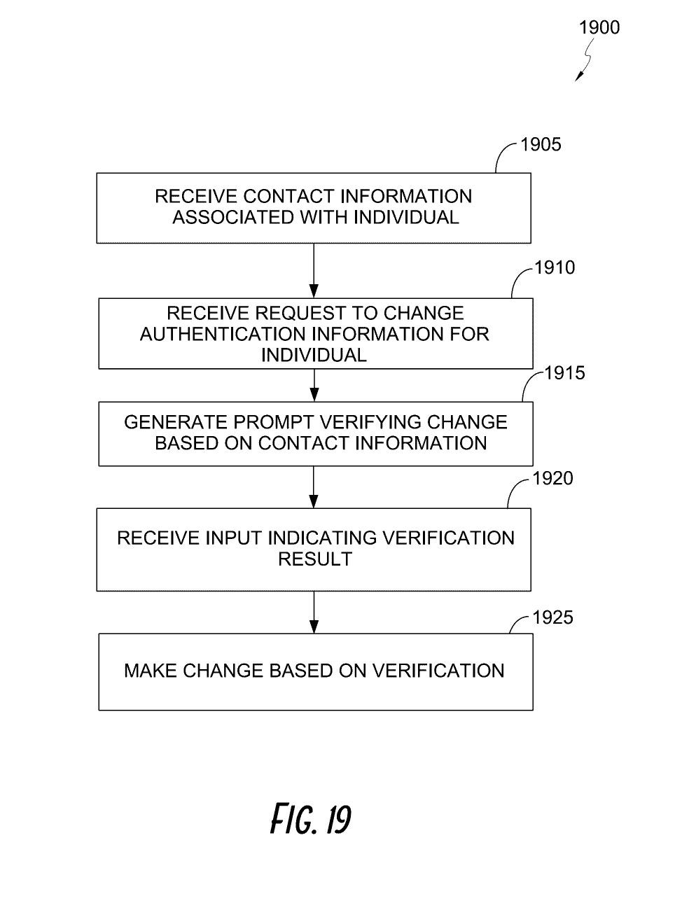

FIG. 19 is a flowchart of a method of verifying changes to a user's authentication information. Method 1900 that may be implemented in at least some of the disclosed embodiments. In some aspects, the method may be implemented by one or more of the servers 502 shown in FIG. 5A. In some aspects, the method may be implemented by a combination of the one or more servers 502 of FIG. 5A, along with one of the client devices 508a-c. In some aspects, the method 1900 may implement one or more of the user interfaces shown in FIGS. 6A-15. For example, the method 1900 may implement the user interface 700 or 800 shown in FIGS. 7 and 8 respectively in some aspects. The method 1900 verifies a request to change one or more aspects of an individual's authentication information. Changing authentication information may include adding, deleting, or updating authentication information. Authentication information may include one or more of a user's user name, password, secret questions, passport number, driver's license number, birthdate, last name, address, retinal scan, and fingerprints. Changing authentication information may also include issuing a new identification card indicating at least one or more of the user's authentication information.

In block 1905, contact information associated with an individual is received. In some aspects, the contact information may be received over a computer network, such as the Internet. In some aspects, the information may be received by the one or more servers 502 shown in FIG. 5. The contact information may include one or more of a phone number, email address, instant messaging user name, twitter handle, and/or user name or other user identifier for an individual in the system implemented by the one or more servers 502 shown in FIG. 5.

In block 1910, a request is received to change authentication information for the individual. In some aspects, the request may be a request to change one or more of the authentication information discussed above. In some aspects, the request may be generated via a user interface presented at a facility associated with the one or more servers 502. For example, in some aspects, an individual may go to a facility with access to the system implemented on the one or more servers 502. The individual may request, for example, that their password for the system be changed, or that they be issued a new identification card based on authentication information stored in the system. The request may be generated by the individual themselves, who may have a user name for the system of FIG. 5. Alternatively, the request may be generated on behalf of the individual, but by an administrative user who works at the facility.

In response to the request of block 1910, method 1900 generates a prompt verifying the change in the authentication information based on the contact information. In some aspects, generating a prompt includes transmitting one or more messages over a computer network defining at least a portion of a user interface to be displayed to a user. In some aspects, the user interface may be substantially similar to one of user interfaces 700 or 800 illustrated in FIGS. 7 and 8 above.

The user interface on which the prompt is displayed may be a different user interface than a user interface that may receive the request to change authentication information for the individual. For example, the request may be received at a facility, such as a post office facility, via a web interface or application running on a computer at the facility. The prompt may be generated at or via a user interface associated with a user name that is associated with the individual. For example, if the individual's name is “Fred,” and “Fred” goes to a facility to change his password, an administrative user named “Peter” may submit the request to change Fred's authentication information. “Peter” may use a computer located at the facility, such as a hard-wired desktop computer, to enter the request for a change. In some aspects, “Peter” may use a mobile device that is logged in with “Peter's” own user name, such as “plaw.” The prompt of block 1915 may be generated to a user's account associated with “Fred,” for example, a user name of “fredn.” The prompt may display on whichever computer is logged in as “fredn.” In some cases, “fredn” may be logged in to a web site application, or to an application running on a mobile device, such as a cell phone.

In block 1920, input is received indicating whether the change is verified. For example, in some aspects, one of controls 712a-b and 812a-b may generate an indicator of whether the change to the authentication information is verified or not. For example, if a user selects one of controls 712a or 812a, the change is not verified, whereas if the user selects one of controls 712b or 812b, the change is verified. In the example above, the input of block 1920 may be received via the user name “fredn,” and thus could be received via any computer in which the user “fredn” is logged in to.

In block 1925, the change is made based on the verification. For example, if the input verifies the change, then the change is made, otherwise, the change is not made. In some aspects, making the change can include updating a database of authentication information with an updated set of data for the individual. In some aspects, making the change can include issuing an ID card to an individual at a facility (which may be indicated by the user interfaces 700 or 800 in various embodiments. In some aspects, making the change may include displaying a user interface to the user requesting the change in block 1910, the user interface indicating that the change may be made.

Those of skill will recognize that the various illustrative logical blocks, modules, circuits, and algorithm steps described as follows, and in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor reads information from, and write information to, the storage medium. In the alternative, the storage medium may be integral to the processor. The processor and the storage medium may reside in an ASIC.

While the above detailed description has shown, described, and pointed out novel features of the development as applied to various embodiments, it will be understood that various omissions, substitutions, and changes in the form and details of the device or process illustrated may be made by those skilled in the art without departing from the spirit of the development. As will be recognized, the present development may be embodied within a form that does not provide all of the features and benefits set forth herein, as some features may be used or practiced separately from others. All changes which come within the meaning and range of equivalency of the claims are to be embraced within their scope.

A person skilled in the art will recognize that each of these sub-systems may be inter-connected and controllably connected using a variety of techniques and hardware and that the present disclosure is not limited to any specific method of connection or connection hardware.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, a microcontroller or microcontroller based system, programmable consumer electronics, network PCs, minicomputers, mainframe computers, distributed computing environments that include any of the above systems or devices, and the like.

As used herein, instructions refer to computer-implemented steps for processing information in the system. Instructions may be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX®, MacOS® or Microsoft Windows®.

The system control may be written in any conventional programming language such as C, C++, BASIC, Pascal, NET (e.g., C#), or Java, and ran under a conventional operating system. C, C++, BASIC, Pascal, Java, and FORTRAN are industry standard programming languages for which many commercial compilers may be used to create executable code. The system control may also be written using interpreted languages such as Perl, Python or Ruby. Other languages may also be used such as PHP, JavaScript, and the like.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

As will be understood by those of skill in the art, in some embodiments, the processes set forth in the following material may be performed on a computer network. The computer network having a central server, the central server having a processor, data storage, such as databases and memories, and communications features to allow wired or wireless communication with various parts of the networks, including terminals and any other desired network access point or means.

What is claimed is:

1. A method of managing health care information for an individual, comprising:
receiving input, via an electronic device, associating one or more additional individuals with the health care information;
receiving electronic contact information for at least one of the additional individuals;
receiving, via an electronic device, a request to access the health care information;
presenting a prompt to the at least one of the additional individuals via their respective electronic contact information in response to the request; and
receiving second input indicating how the request should be processed; and
processing the request based on the second input.

2. The method of claim 1, wherein the receiving of the request to access the health care information comprises receiving a request to transfer the health care information from a first health service provider to a second health service provider.

3. The method of claim 1, wherein the receiving of the request to access the health care information comprises receiving a request to issue an identification card based on the health care information.

4. The method of claim 1, wherein presenting a prompt comprises one of displaying a user interface on an electronic display, or transmitting a network message to a client device configured to cause the client device to display the prompt.

5. The method of claim 1, wherein receiving of the request to access the health care information comprises a request to reset a password protecting the health care information.

6. The method of claim 5, wherein the request indicates a facility from which the password reset is initiated.

7. The method of claim 6, presenting the prompt to indicate the facility.

8. An apparatus for managing health care information for an individual, comprising:
one or more electronic hardware processors;
a memory storing instructions that configure the one or more electronic hardware processors to:
receive input, associating one or more additional individuals with the health care information;
receive electronic contact information for at least one of the additional individuals;
receive a request to access the health care information;
present a prompt to the at least one of the additional individuals via their respective electronic contact information in response to the request;
receive second input indicating how the request should be processed; and
process the request based on the second input;

9. The apparatus of claim 8, wherein the receiving of the request to access the health care information comprises receiving a request to transfer the health care information from a first health service provider to a second health service provider.

10. The apparatus of claim 8, wherein the receiving of the request to access the health care information comprises receiving a request to issue an identification card based on the health care information.

11. The apparatus of claim 8, wherein the processor is configured to present the prompt by one of displaying a user interface on an electronic display, or transmitting a network message to a client device configured to cause the client device to display the prompt.

12. The apparatus of claim 8, wherein receiving of the request to access the health care information comprises a request to reset a password protecting the health care information.

13. The apparatus of claim 12, wherein the request indicates a facility from which the password reset is initiated.

14. The apparatus of claim 13, presenting the prompt to indicate the facility.

15. A computer readable storage medium comprising instructions that when executed cause one or more electronic hardware processors to perform a method of managing health care information for an individual, the method comprising:
receiving input associating one or more additional individuals with the health care information;
receiving electronic contact information for at least one of the additional individuals;
receiving a request to access the health care information;
presenting a prompt to the at least one of the additional individuals via their respective electronic contact information in response to the request;
receiving second input indicating how the request should be processed; and
processing the request based on the second input;

16. The computer readable storage medium of claim 15, wherein the receiving of the request to access the health care information comprises receiving a request to transfer the health care information from a first health service provider to a second health service provider.

17. The computer readable storage medium of claim 15, wherein the receiving of the request to access the health care information comprises receiving a request to issue an identification card based on the health care information.

18. The computer readable storage medium of claim 15, wherein presenting a prompt comprises one of displaying a user interface on an electronic display, or transmitting a network message to a client device configured to cause the client device to display the prompt.

19. The computer readable storage medium of claim 15, wherein receiving of the request to access the health care information comprises a request to reset a password protecting the health care information.

20. The computer readable storage medium of claim 19, wherein the request indicates a facility from which the password reset is initiated.
